(19) United States
(12) Patent Application Publication
(10) Pub. No.: US 2015/0172576 A1
(43) Pub. Date: Jun. 18, 2015

(54) REAL TIME DYNAMIC BAD PIXEL RESTORATION METHOD

(71) Applicant: ASELSAN ELEKTRONIK SANAYI VE TICARET ANONIM SIRKETI, ANKARA (TR)

(72) Inventor: Mustafa ERBUDAK, ANKARA (TR)

(73) Assignee: ASELSAN ELEKTRONIK SANAYI VE TICARET ANONIM SIRKETI, ANKARA (TR)

(21) Appl. No.: 14/561,234

(22) Filed: Dec. 5, 2014

(30) Foreign Application Priority Data
Dec. 5, 2013 (TR) 2013/14269

(51) Int. Cl. H04N 5/367; H04N 5/33

(52) U.S. Cl. CPC H04N 5/3675; H04N 5/33

(57) ABSTRACT

The present invention relates to infrared imaging devices using matrix type detector and restoring the bad pixels in these devices by detecting them. The objective of the present invention is to provide a real time dynamic bad pixel correction method which can perform bad pixel identification and correction process in an image taken from a thermal imaging device in each image frame.

### FIELD OF THE INVENTION

The present invention relates to infrared imaging devices using matrix type detector and restoring the bad pixels in these devices by detecting them.

### BACKGROUND OF THE INVENTION

The bad pixels are found during pixel equalization (NUC—Non Uniformity Correction) process in the state of the art. This process is carried out during the first startup of the imaging device. Since the image corrupts in time in some systems, bad pixel finding process is carried out by repeating NUC process with the user command.

There are different methods for identifying a pixel as bad. The method which is most used is to mark the ones deviating a certain amount from the general average of the pixel gain and offset values calculated during NUC process as bad pixel. Another method is to find the pixels deviating as a certain value from its immediate surrounding by looking at a thermal equal surface after the NUC process is completed. After the bad pixels are found, they are substituted (corrected) with the good pixels. For this process, the good pixel in the closest neighborhood of the bad pixel should be determined. Then in the live image, the pixel once it is decided to be bad is continuously canceled and substituted with the selected good pixel.

In the present methods, the process is performed once in the start or with long intervals. However, bad pixel characteristics may change in time in IR detectors. Some bad pixels can become proper as well as the good pixels can become bad. It is not possible to detect these pixels with the present methods.

Some bad pixels continuously come and go between bad and good. The effect of these on the image is as blinking, for this reason it is called blinking. Since the current methods look for a bad pixel by averaging in a certain time, they cannot always catch them.

The output curves of some pixels may be more nonlinear. These pixels can become bad pixels by deviating from the pixels around them depending on the temperature of the target being looked at. Since finding bad pixels is performed by looking at flat surfaces at a certain temperature to certain infrared radiation) in the current methods, it is not always possible to find this type of pixels.

U.S. Pat. No. 8,228,405 discloses substituting the degraded pixels with the new ones by using NUC (non-uniformity correction) process. In the invention disclosed in this document, an equal reference surface should be looked at in order to perform the process. Therefore, the process requires user interference.

International Patent Document no WO2012063265 discloses sensor arrays adapted for detecting and adapting bad pixels, and a method for correcting the bad pixels. Detection and correction process is started with the user command in the invention disclosed in the document; automatic iteration is riot performed in each image frame. Furthermore, the method which is disclosed operates as a detailed analysis comprising large processing load and for minimizing error rate, and the number of parameters required to adjusted is large.

### SUMMARY OF THE INVENTION

The objective of the present invention is to provide a real time dynamic bad pixel correction method which can perform bad pixel identification and correction process in an image taken from a thermal imaging device in each image frame.

### BRIEF DESCRIPTION OF THE DRAWINGS

FIG. 1 is the flow chart of the real time dynamic bad pixel correction method.

FIG. 2 is a flow chart of the dynamic bad pixel correction method.

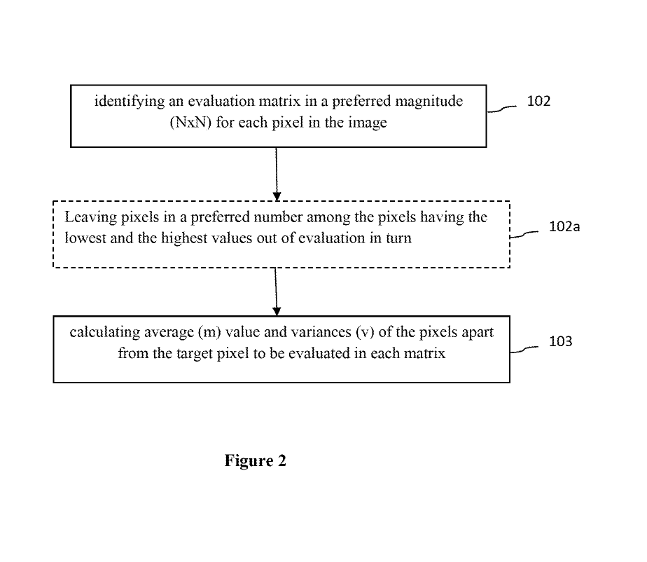

### DETAILED DESCRIPTION OF THE INVENTION

The dynamic bad pixel correction method developed to fulfill the objectives of the present invention is illustrated in the accompanying figure, in which:

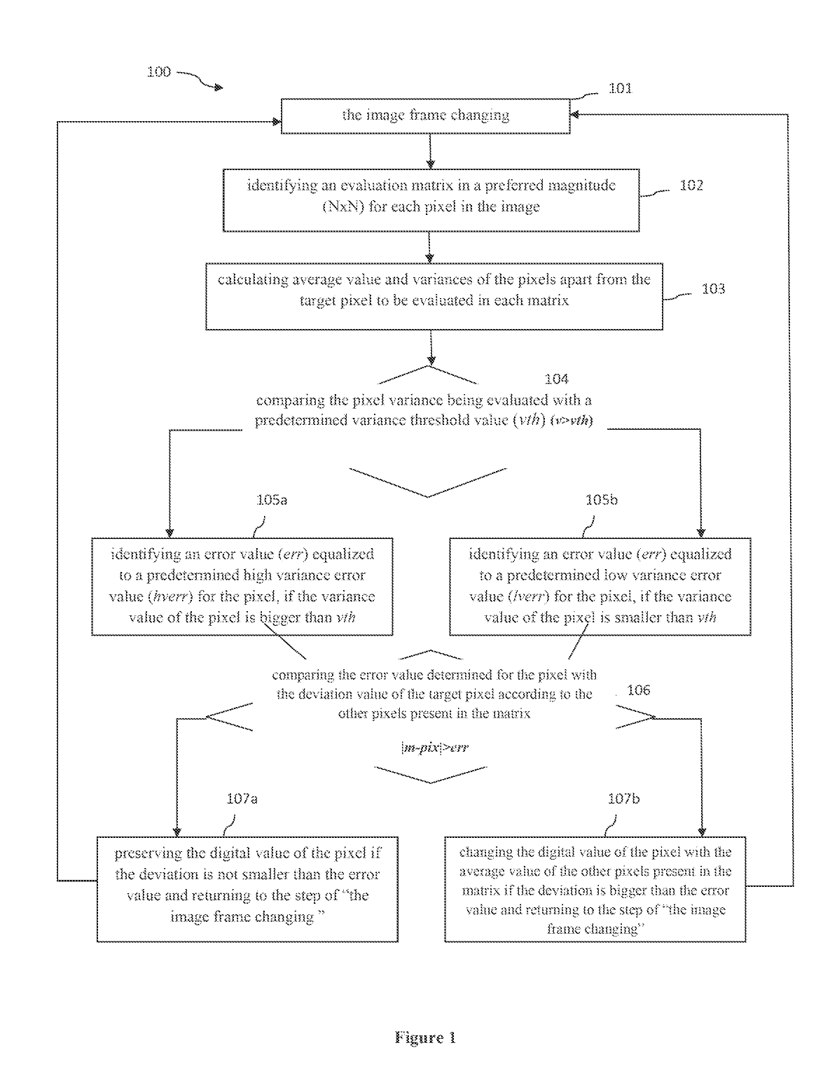

FIG. 1 is the flowchart of the real time dynamic bad pixel correction method

The dynamic bad pixel correction method (100) developed to fulfill the objective of the present invention essentially comprises the steps of
the image frame changing (101),
identifying an evaluation matrix in a preferred magnitude (N×N) for each pixel in the image (102),
calculating average value and variances of the pixels apart from the target pixel to be evaluated in each matrix (103),
comparing the pixel variance being evaluated with a predetermined variance threshold value (vth) (104),
identifying an error value (err) equalized to a predetermined high variance error value (hverr) for the pixel, if the variance value of the pixel is bigger than vth (105a),
identifying an error value (err) equalized to a predetermined low variance error value (lverr) for the pixel, if the valiance value of the pixel is smaller than vth (105b),
comparing the error value determined for the pixel with the deviation value of the target pixel according to the other pixels present in the matrix (106),
preserving the digital value of the pixel if the deviation is smaller than the error value and returning to the step of the “image frame changing 8101)” (107a),
changing the digital value of the pixel with the average value of the other pixels present in the matrix if the deviation is bigger than the error value and returning to the step of “the image frame changing (101)” (107b).

In a preferred embodiment of the dynamic bad pixel correction method (100), the value of each pixel neighboring to the target pixel is determined after the step of “identifying an evaluation matrix in a preferred magnitude (N×N) for each pixel in the image (102)”, the determined values are sorted and a preferred number of pixels among the pixels having the smallest and biggest values are left out of the evaluation one by one (102a). For example, 2 of the pixels having the biggest value and 2 of the pixels having the smallest value among 8 neighbor pixels in an evaluation matrix of 3×3 pixels are left out of the evaluation, and it is continued with the steps with the remaining 4 pixels. With this embodiment, the possibility of the pixels used in the evaluation being bad is tried to be minimized.

In the dynamic bad pixel correction method (100) the process of finding and correcting the bad pixel is repeated in each image frame. For this process each pixel (pix) in an image frame is evaluated according to the neighbor pixels in N×N matrix around it. The evaluated pixel is located at the center of the matrix. After a matrix is determined for each pixel in this way, the average (m) and variance (v) of the ones (pixᵢ) that are not left out of the evaluation among the neighbor pixels are calculated with the following equations (103).

$$m = \frac{{{\sum }_{1}}^{n} {pix}_{i}}{n} , v = \frac{{\sum }_{1}^{n} {pix}_{i}^{2}}{n}$$

A predetermined variance threshold (vth) value is used for comparing with the variance value (v) of the target pixel. The variance threshold value is determined according to the detector characteristics with test method. After the variance value of the target pixel is compared with the variance threshold value (104), an error value (err) is determined for that pixel. The high variance error value which is one of the said error values referred to as high variance error value (hverr) and the low variance error value (lverr) are determined compatible with the detector characteristics with a test method as variance threshold value. The low variance error value (lverr) is changed dynamically during operation.

The low variance error value is determined with a control loop dynamically while the imaging device is operating. For this process the number of possible bad pixels in the detector is decided considering the detector operability percentage and with general experience. The control loop changes the low variance error value (lverr) parameter such that the expected bad pixel number is reached.

The error value for target pixel is determined as follows:

v>vth→err=hverr

v≦vth→err=lverr

According to the above mentioned equations, the error value (err) is determined by comparing the variance value (v) of the target pixel with the variance threshold value (vth) (105a), (105b).

After the error value is determined, deviation value is calculated according to the pixels around the target pixel, and the said value is compared with the error value determined for that pixel (106). If the deviation value is bigger than the error value, the pixel is marked as bad. The pixel value which is marked as bad is changed with the average of the neighbor pixels and the correction process is completed (107b). If the deviation value is smaller than the error value, the value of the pixel is not changed (107a).

|m−pix|>err→pix=m

After the steps of correction and not changing the value of the pixel, all steps are repeated in the new image frame. With this loop which is provided, bad pixel detection and changing process is performed dynamically during the operation of the imaging device, there is no need for resetting the device or user interference. The processes disclosed in the detailed description are performed for each pixel in the image, that is each pixel is evaluated as the target pixel.

In the real time dynamic bad pixel correction method (100), the purpose for using valiance is to understand whether the reason for deviation of the pixel from the surrounding is being at the edge of the objects in the image or being a bad pixel. High variance error value (hverr) is used for the detection of the pixels on the edge. It enables to find the pixels which are located at the edge by keeping the value high but completely dead.

Low variance error calculation (lverr) which is a slow loop and all other processes should be performed in real time, therefore it can be performed with a simple FPGA or a similar integrated circuit which can perform logic operations. Division process used for this purpose is assigned such that it can be performed with bit shifting.

With the real time dynamic bad pixel correction method (100), the process load is minimized, and it is aimed to obtain an image which will not bother the user by operating fast instead of finding all bad pixels.

1. A bad pixel correction method essentially comprising:
changing the image frame;
identifying an evaluation matrix in a preferred magnitude (N×N) for each pixel in the image;
calculating average value and variances of the pixels apart from a target pixel to be evaluated in each matrix;
comparing a pixel variance being evaluated with a predetermined variance threshold value (vth);
identifying an error value (err) equalized to a predetermined high variance error value (hverr) for the pixel, if the variance value of the pixel is bigger than vth;
identifying an error value (err) equalized to a predetermined low variance error value (lverr) for the pixel, if the variance value of the pixel is smaller than vth;
comparing the error value determined for the pixel with a deviation value of the target pixel according to the other pixels present in the matrix;
preserving a digital value of the pixel if the deviation value is smaller than the error value and returning to the step of “changing the image frame”;
changing the digital value of the pixel with the average value of the other pixels present in the matrix if the deviation is bigger than the error value and returning to the step of “changing the image frame”.

2. The bad pixel correction method according to claim 1, wherein a step of “leaving pixels in a preferred number among the pixels having the smallest and biggest values out of evaluation one by one by sorting the values of each pixel neighboring to the target pixel” is performed after the step of “identifying an evaluation matrix in a preferred magnitude (N×N) for each pixel in the image”.

3. The bad pixel correction method according to claim 1, wherein the low variance error value is changed considering the number of possible bad pixels in the detector, operability percentage of the detector in a dynamic way while the imaging device is operating such that it will reach the preferred bad pixel number.

4. The bad pixel correction method according to claim 2, wherein the low variance error value is changed considering the number of possible bad pixels in the detector, operability percentage of the detector in a dynamic way while the imaging device is operating such that it will reach the preferred bad pixel number.
